(19) United States
(12) Patent Application Publication
(10) Pub. No.: US 2002/0103569 A1
(43) Pub. Date: Aug. 1, 2002

(54) Programmable logic controller driven inventory control systems and methods of use

(76) Inventor: Steven L. Mazur, Wilder, ID (US)

Correspondence Address: Joseph A. Walkowski,, TRASK BRITT, P.O. Box 2550, Salt Lake City, UT, 84110, US

(21) Appl. No.: 09/774,912

(22) Filed: Jan. 31, 2001

(51) Int. Cl. G06F 7/00

(52) U.S. Cl. 700/216

(57) ABSTRACT

A programmable logic controller driven inventory control system for use with a pick or assembly line. The programmable logic controller may be configured to interface with and control the various components of the pick line and inventory control system, as well as to interface with a computer system containing inventory databases. The programming of the programmable logic controller and, hence, operation of the inventory control system and pick line may be altered in real time during operation.

### BACKGROUND OF THE INVENTION

1. Field of the Invention

The present invention relates generally to inventory management on a pick or assembly line and, specifically, to apparatus and methods for managing inventory using an inventory control system driven by a programmable logic controller.

2. State of the Art

Manufacturing facilities, warehouses, distributers, large department stores, and the like often require complex systems to manage large quantities of inventory. As used herein, the term “inventory” refers generally to goods or materials being held for future use and/or sale. For example, a manufacturer may have completed goods awaiting shipment to customers, as well as raw materials and parts for subsequent use in the manufacture or assembly of goods or the delivery of services. Similarly, a warehouse or distributor, as well as a large department store, may have goods on hand for shipment or sale to customers. Such materials and goods will be generally referred to herein as simply “inventory items” or “parts.”

Shown in FIG. 1 is an exemplary embodiment of a conventional assembly or pick line 100. The pick line 100 includes a conveyor 120, or other suitable transport device, extending and movable through a plurality of product zones 130, such as, for example, four product zones 130a-d. The conveyer 120 is configured to move one or more pallets or trays 5 sequentially through the product zones 130. Within each of the product zones 130a-d are a plurality of part bins 135, each part bin 135 adapted to store or retain a specific type or classification of part or inventory item, as desired. Generally, all of the part bins 135 within a particular product zone 130 will store parts or inventory items of a particular product group. As a pallet 5 travels through a product zone 130, all or a specified portion of the parts stored within the part bins 135 of that product zone 130 are loaded onto the pallet 5. The various parts collected on a pallet 5 may, for example, be incorporated into a device being assembled on the pallet 5, retained on the pallet 5 for subsequent assembly, or simply collected on the pallet 5 for shipment to a customer.

By way of example, the pick line 100 may comprise a portion of a computer manufacturing facility. Each of the product zones 130a-d includes a plurality of part bins 135, each part bin 135 containing a specific part, wherein all of the part bins 135 of a product zone 130 retain a particular grouping of parts. For example, the first product zone 130a may include a plurality of types of computer housings or chassis, each part bin 135 of that product zone 130a retaining a specific size or configuration of computer chassis. A second product zone 130b may include a plurality of types of motherboards, wherein each part bin 135 within the second product zone 130b retains a specific model or configuration of motherboard. A third product zone 130c may include a plurality of types of memory modules, each part bin 135 of the third product zone 130c storing a particular type or size of memory module. Yet another product zone 130d may include a plurality of types of hard disk drives, a particular model or type of hard disk drive being stored within each of the part bins 135 within that product zone 130d. Other product zones may includes product groupings of video cards, video displays, disk drives, CD-ROM drives, keyboards, sound cards, and the like.

As the various computer parts are transferred from the part bins 135 within a product zone 130 to a pallet 5 present in that product zone 130, those parts may be incorporated into a computer being assembled on the pallet 5. Alternatively, all of the parts transferred from the part bins 135, as the pallet 5 traverses the product zones 130a-d on conveyer 120, may be collected on the pallet 5, and the pallet 5 transferred elsewhere in the manufacturing facility for assembly. As a further alternative, all of the computer parts withdrawn from the part bins 135 of pick line 100 may simply be collected on the pallet 5 for direct shipment to a customer. Also, although only one pick line 100 is depicted in FIG. 1, those of ordinary skill in the art will understand that a computer manufacturing facility, as well as other types of manufacturing facilities and warehouses, may employ multiple pick or assembly lines.

Referring again to FIG. 1, each product zone 130a-d includes a gate 270 linked, either electrically or mechanically, to the conveyer 120 for halting movement thereof when a pallet 5 has entered that product zone 130 to receive an inventory item or items. The gate 270 may comprise a brake or other mechanical linkage configured to physically contact the conveyer 120 and halt movement thereof. Alternatively, the gate 270 may comprise an electrical switch that is electrically coupled to the conveyor's drive motor and configured to cut off power thereto. Each product zone 130a-d also includes at least one sensor 280 for sensing the presence of a pallet 5 in that product zone 130. The sensor 280 may comprise any suitable sensor known in the art, including optical sensors, capacitive sensors, inductive sensors, and contact-type proximity sensors. Further, each part bin 135 of the pick line 100 includes a pick module 260 associated therewith, the operation of the pick modules 260 to be explained in greater detail below.

Shown in FIG. 2 is an exemplary embodiment of a conventional inventory control system 200 for use with the pick line 100 of FIG. 1. The inventory control system 200 includes a computer system 240 electrically coupled to a plurality of command modules 250. The computer system 240 generally comprises a computer or server configured to store and maintain a database of inventory items to be consumed in the pick or assembly line 100. In addition to maintaining an inventory database, such a computer or server may also maintain a database of outstanding work order or job numbers to be processed. The computer system 240 is further configured to store and run one or more programs controlling operation of the pick line 100, as well as the inventory control system 200. Those of ordinary skill in the art will understand that the computer system 240 may actually comprise separate components. For example, the computer system 240 may comprise a server adapted to store and update a database of inventory items and a separate computer adapted to store and run one or more programs controlling operation of the pick line 100 and inventory control system 200, the computer also being configured to interface with the server database and to transfer data therefrom to the command modules 250, as will be explained in greater detail below.

An RS-232/422 adapter 245 may be used to couple the computer system 240 to the command modules 250. Electrically coupled to each of the command modules 250 are a plurality of the pick modules 260. A command module may be coupled to a portion of the pick modules 260 for a particular product zone 130a-d, all of the pick modules 260 for a particular product zone 130a-d, or the pick modules 260 associated with two or more product zones 130a-d, as is desired. Also electrically coupled to the command modules 250 are the gates 270 and sensors 280. A command module may, for example, be electrically coupled to the gate 270 and sensor 280 associated with a particular product zone 130a-d, the gates 270 and sensors 280 associated with two or more product zones 130a-d, the gates 270 associated with a plurality of product zones 130a-d, or the sensors 280 associated with a plurality of product zones 130a-d.

Each command module 250 essentially functions as a data link between the computer system 240 and the other components—e.g., pick modules 260, gates 270, and sensors 280— electrically coupled thereto. For example, a command module 250 may format data received from the computer system 240 for use by a pick module 260, or a command module 250 may format data received from a pick module 260 or sensor 280 for use by computer system 240. However, as should be realized from the description above, there is not necessarily a correspondence between a command module 250 and one of the product zones 130a-d, because a command module may be electrically coupled to the pick modules 260, gates 270, and sensors 280 of two or more product zones 130a-d, and the pick modules 260, gate 270, and sensor 280 of a particular product zone 130 may be coupled to multiple command modules 250.

As noted above, a pick module 260 is associated with one of the part bins 135 of the pick line 100, the pick module 260 generally being physically attached to, or located in close proximity to, its mating part bin 135. A pick module 260 comprises a user interface including at least a user-readable output, such as a digital display, and a user input, such as a button or a plurality of buttons (i.e., a keypad). The user-readable output may identify—by simply illuminating a digital display or, alternatively, by illuminating an LED— for an operator which part bin or part bins 135 are to have parts removed therefrom. Further, for a pick module 260 that has been identified (i.e., illuminated), the user-readable output may also provide the operator with the number of parts to be withdrawn from its corresponding part bin 135, as well as a work order or invoice number, a part number, and/or other suitable information as desired. The user input on a pick module 260 enables an operator to inform—by, for example, pressing a button or a series of buttons— the computer system 240 that the specified number of parts from an identified part bin 135 have been transferred to a pallet 5 for inclusion in a work order.

The inventory control system 200 may also include a plurality of video displays 290, at least one video display generally being associated with each of the product zones 130a-d. A video display 290, such as an ASCII display, can be used to provide information to a user, including work order or invoice numbers, part numbers, error messages, and other suitable information, as desired. Each video display 290 is also coupled to the computer system 240 via any one of the command modules 250.

In addition, the inventory control system 200 may include an input device 255. The input device 255 enables an operator to input a command or data into the inventory control system 200 informing the inventory control system 200 that the operator is commencing a job, such as processing a work order. By way of example, the input device 255 may comprise a bar code scanner configured to scan a bar code provided on a hard-copy of a work order or invoice. Upon scanning the bar code and inputting the corresponding work order number, the inventory control system 200 is enabled or turned on and commences operation. Based upon the work order number, the inventory control system 200 knows what data to download or transfer out of the computer system 240. Alternatively, the inventory control system 200 may be enabled by a command received from the computer system 240 or simply by the press of a button or switch.

The conventional pick line 100 and inventory control system 200 having been described above, operation of the pick line 100 in conjunction with the inventory control system 200 will now be explained. Operation of the pick line 100 and inventory control system 200 will be explained with reference to the example of a computer manufacturing facility, as set forth above. The process begins with the entry of a work order number or other command at the input device 255. Again, the input device 255 may be a bar code scanner for reading a bar code from the hard-copy of a work order. The command module 250 coupled with the input device 255 then sends a signal to the computer system 240 indicating that the identified work order will be processed and, based upon that work order number, the computer system 240 returns to the command modules 250 a data set identifying the inventory items—e.g., a computer chassis— in a first product zone 130a associated with the specified work order.

At this juncture, it should be noted that the command modules 250 are connected in series to the computer system 240. The first command module 250—i.e., the command module 250 first in line and directly coupled to the computer system 240 (via RS232/422 adapter 245, if necessary)— receives the data set from the computer system 240 and, for each pick module 260 coupled to the first command module 250 and associated with a part bin 135 in the first product zone 130a containing an identified part, the first command module 250 sends a signal to each of these pick modules 260. The signal provided to a pick module 260 in the first product zone 130a illuminates a light or digital display on that pick module 260 and also provides an indication of how many inventory items to withdraw from the illuminated part bin 135 for transfer to a pallet 5 resting on the conveyer 120 within the first product zone 130a, the first product zone gate 270 halting movement of conveyor 120 to maintain the pallet 5 within the first product zone 130a.

The first command module 250 then sends the data set to the next-in-line, or second, command module 250. For each pick module 260 coupled to the second command module 250 and associated with a part bin 135 in the first product zone 130a containing and identified part, the second command module 250 sends a signal to each of these pick modules 260. Again, the signal provided by the second command module 250 to a pick module 260 in the first product zone 130a illuminates a light or digital display on that pick module 260 and also provides an indication of how many inventory items to withdraw from the illuminated part bin 135 for transfer to the pallet 5 in the first product zone 130a. The second command module 250 then provides the data set to the next-in-line command module 250, and so forth, until all of the pick modules 260 associated with a part bin 135 in the first product zone 130a containing an identified part (i.e., a part listed on the work order being processed) have been illuminated.

Upon illumination of all pick modules 260 associated with a part bin 135 in the first product zone 130a containing a needed part, the operator removes, or picks, the part or parts from the identified part bins 135 and places the parts on the pallet 5 in the first product zone 130a. As the operator picks the required number of parts from an identified product bin 135 (as noted on the pick module 260 associated with that part bin 135), the operator presses a button or series of buttons on the associated pick module 260 and the pick module 260 transfers a corresponding signal back to its command module 250, and that command module 250, in turn, provides a signal to the computer system 240 indicating that the specified part or parts (i.e., those in the part bin 135 for which the operator pressed the button) have been added to the work order in progress and that those items have been removed from the overall inventory. Activation of the button on a pick module 260 also de-illuminates that pick module 260, thereby providing an indication to the operator that all necessary parts have been withdrawn from the part bin 135 associated with that pick module 260. All of the identified part bins 135 in the first product zone 130a are processed in a similar fashion by the operator.

Once all of the identified part bins 135 in the first product zone 130a have been processed and the necessary parts placed on the pallet 5, the command module 250 coupled to the gate 270 in the first product zone 130a sends a command signal to that gate 270, directing the gate 270 to disengage the conveyer 120, enabling the conveyer 120 to transport the pallet 5 in the first product zone 130a to the next or second product zone 130b. The sensor 270 in the second product zone 130b senses the presence of the pallet 5 in the second product zone 130b and provides a corresponding signal to its command module 250, and that command module 250 sends a command signal to the gate 280 in the second product zone 130b directing that gate 280 to engage and halt the conveyer 120, such that the pallet 5 is now in the second product zone 130b. One of the command modules 250 then provides a signal to the computer system 240 informing the same that the command modules 250 are now ready to receive the data set corresponding to the inventory items in the second product zone 130b, which inventory items may, for example, comprise varying types of motherboards.

Upon receipt of the data set for the second product zone 130b, the first command module 250 illuminates the pick modules 260 associated with each part bin 135 in the second product zone 130b containing an identified part or parts, as noted above. That data is then provided to all other command modules 250, such that they may also illuminate their respective pick modules 260 associated with a part bin 135 in the second product zone 130b containing a needed part. The operator then transfers all of the required parts to the pallet 5 resting on the conveyer 120 in the second product zone 130b and, via an operator input at each pick module 260 (i.e., pressing a button), the pick modules 260 provide signals to their respective command modules 250, which, in turn, transfer the information to the computer system 240 so that the computer system 240 can delete the second zone parts from the work order being processed and from the inventory as a whole.

The above-described process is then continued for all other product zones 130c, 130d until the entire work order has been processed. The gates 270 in the third and fourth product zones 130c, 130d are used to halt the conveyer therein, respectively, such that the third product zone parts—e.g., memory modules— and the fourth product zone parts—e.g., hard disk drives— may be added to the pallet 5, as necessary. It should be noted that, as the pallet 5 is transferred from the first product zone 130a to the second product zone 130b, another pallet 5 may be moved into the first product zone 130a for simultaneous processing of another, separate work order. Also, the computer system 240 may transfer data—such as an error message stating that a particular inventory item has not be added to a work order, as required— via a command module 250 to a display 290, there typically being a display 290 in each product zone 130a-d. An operator in that product zone 130a-d, or moving with a pallet 5 through all product zones 130a-d, can receive that data and take appropriate action.

The conventional inventory control system 200, however, exhibits a number of problems during operation with, and control of, the exemplary pick line 100. For example, because the inventory control system 200 and, hence, the pick line 100 are controlled by a centralized computer system 240 or combination of computers and/or servers, it can be difficult to isolate software or order-specific errors and/or discrepancies. As a result, it is difficult to troubleshoot the conventional inventory control system 200, especially for maintenance personnel without formal training in computer programming. These problems are exacerbated by a need to shut down the computer system 240 and recompile the computer code stored therein in order to make changes and/or to correct errors. Further, the conventional inventory control system 200 is not amenable to real-time changes to its programming or to its database during the processing of a work order. If, for example, a part number required correction or a system timing parameter (e.g., conveyer speed) required adjustment, such changes or adjustments could not be accomplished while a work order was in progress. Rather, a work order or orders in progress would have to be completed and any part number discrepancies manually corrected or timing adjustments made after processing.

Accordingly, a need exists in the art for an inventory control system adapted for use with a pick or assembly line that is easy to troubleshoot and isolate problems. Further, a need exists for such an inventory control system that can be maintained by personnel who have only minimal training in computer programming. Also, such an inventory control system must be reliable and adaptable to existing pick and assembly lines.

### SUMMARY OF THE INVENTION

Embodiments of the present invention comprise a programmable logic controller (PLC) driven inventory control system for use with a pick or assembly line. A pick line generally comprises a conveyer extending through a plurality of product zones, each of the product zones including a plurality of part bins. The part bins each store a specific type or classification of inventory item, and all of the part bins within a product zone may store inventory items of the same general product group. The conveyer is configured to move trays or pallets sequentially through the product zones to receive thereon various identified inventory items. Associated with each part bin is a pick module, and associated with each product zone is a gate and sensor. The sensor is configured to detect the presence of a pallet in its product zone, and the gate is configured to halt movement of the conveyer when a pallet arrives in that product zone.

An inventory control system according to the invention generally comprises a PLC electrically coupled to a computer system and a plurality of command modules. The PLC may be further coupled to an input device, the gates, and the sensors. The computer system comprises a computer or server configured to store and maintain a database of inventory items to be consumed in the pick line, and the computer system may also store a database of outstanding work orders to be processed. The input device enables an operator to input a command or data into the PLC informing the PLC that the operator is commencing a job, such as processing a work order. Also, one or more video displays may be coupled to a command module, one such video display generally being associated with each of the product zones.

Electrically coupled to each of the command modules may be a plurality of the pick modules. A command module functions as a data link between its associated pick modules and the PLC. A pick module comprises a user interface including at least a user-readable output and a user input. The user-readable output may identify for an operator which part bin or part bins are to have parts picked therefrom, as well as the number of parts to be picked from that part bin. The user input on a pick module enables an operator to inform the PLC that the specified number of parts from an identified part bin have been picked and added to a work order being processed.

The PLC is typically programmed to interface with the computer system and with the command modules, input device, pick modules, gates, sensors, and video displays. For example, the PLC may be programmed to receive work order data from the computer system database and to format that data for use by command modules and, similarly, may be programmed to receive electrical signals from the command modules and to format those signals for use by the computer system. Information displayed at the user-readable output of the pick modules and video displays may be altered by reprogramming the PLC. The PLC is also programmed to control operation of the numerous components—e.g., the gates, sensors, and conveyor— comprising the pick line and inventory control system. Further, the PLC is programmed to track one or more work orders in progress and to internally keep track of the inventory items being picked from the part bins and added to a work order, and the PLC may also be programmed to generate statistics relating to the processing of a number of work orders. The PLC's programming may be modified in real time during operation.

Operation of the pick line and inventory control system may begin with entry of a work order number or other command at the input device, which then provides the work order number directly to the PLC, and the PLC subsequently sends a signal to the computer system indicating that the PLC is ready to receive data associated with that work order number. The computer system returns to the PLC a data set identifying all of the inventory items associated with the specified work order number, the PLC being programmed with the part bin corresponding to each type of part along the pick line.

Next, the PLC sends out to the first-in-line command module a data set corresponding to all required parts in the first product zone. For each pick module coupled to the first command module and associated with a part bin in the first product zone containing an identified part, the first command module sends a signal thereto directing that a digital display be illuminated and indicating the number of inventory items to be picked from the associated part bin.

Upon illumination of all pick modules associated with a part bin in the first product zone containing a needed part, the operator picks the part or parts from the identified part bins and places the parts on a pallet resting on the conveyer in the first product zone. As the operator picks the required number of parts from an identified product bin, the operator activates the user input (i.e., pushes a button) on the associated pick modules, and the pick module transfers a corresponding verification signal back to its command module, and that command module, in turn, provides a signal to the PLC indicating that the specified part or parts have been added to the work order in progress. The PLC internally keeps track of which items have been added to that work order. Activation of the user input on a pick module also de-illuminates that pick module to provide an indication to the operator that all necessary parts have been withdrawn from the associated part bin. All of the identified part bins in the first product zone are processed in a similar fashion by the operator.

Once all of the identified part bins in the first product zone have been processed and the necessary parts placed on the pallet, the PLC sends a command signal to the gate of the first product zone, directing that gate to disengage the conveyer, enabling the conveyer to transport the pallet in the first product zone to the next or second product zone. The sensor in the second product zone senses the presence of the pallet in the second product zone and provides a corresponding signal to the PLC, which sends a command signal to the second product zone gate directing that gate to engage and halt the conveyer, such that the pallet is now in the second product zone. The PLC then sends a second data set to the corresponding command module that identifies all the required parts for that work order that are located in the second product zone. The above-described procedure is then carried out for all other product zones in a similar manner. During the processing of a work order, the PLC may send a message, such as an error message, to a display associated with one of the product zones. Upon completion of a work order, the PLC may send a signal to the computer system, enabling the computer system to update its database of outstanding work orders or its inventory database.

In another embodiment, a common command module is associated with a plurality of product zones, so that the common command module may execute the PLC commands for a plurality of product zones.

In yet another embodiment, the PLC is not programmed with the product groupings for each product zone, and the computer system sends to the PLC only the part identification data corresponding to one product zone at a time.

In still another embodiment, the PLC is not programmed with the part bin corresponding to each part along the pick line, and the computer system provides the PLC with the part bin assigned to each inventory item required for a work order.

In yet a further embodiment of the present invention, a network of PCs is coupled to the PLC by a server, enabling an operator to log into the server via one of the PCs and to access data on the PLC or to input data, such as a work order number, to the PLC.

### BRIEF DESCRIPTION OF THE SEVERAL VIEWS OF THE DRAWINGS

While the specification concludes with claims particularly pointing out and distinctly claiming that which is regarded as the present invention, the features and advantages of this invention can be more readily ascertained from the following detailed description of the invention when read in conjunction with the accompanying drawings, in which:

FIG. 1 shows a schematic view of an exemplary embodiment of a conventional pick or assembly line;

FIG. 2 shows a schematic view of an exemplary embodiment of a conventional inventory control system for the pick or assembly line of FIG. 1;

FIG. 3 shows a schematic view of an exemplary embodiment of a conventional programmable logic controller;

FIG. 4 shows a flow chart of a scan cycle of a conventional programmable logic controller;

FIG. 5 shows a schematic view of a pick or assembly line according to the present invention;

FIG. 6 shows a schematic view of an inventory control system according to the present invention; and

FIG. 7 shows a schematic view of an alternative embodiment of an inventory control system according to the invention.

### DETAILED DESCRIPTION OF THE INVENTION

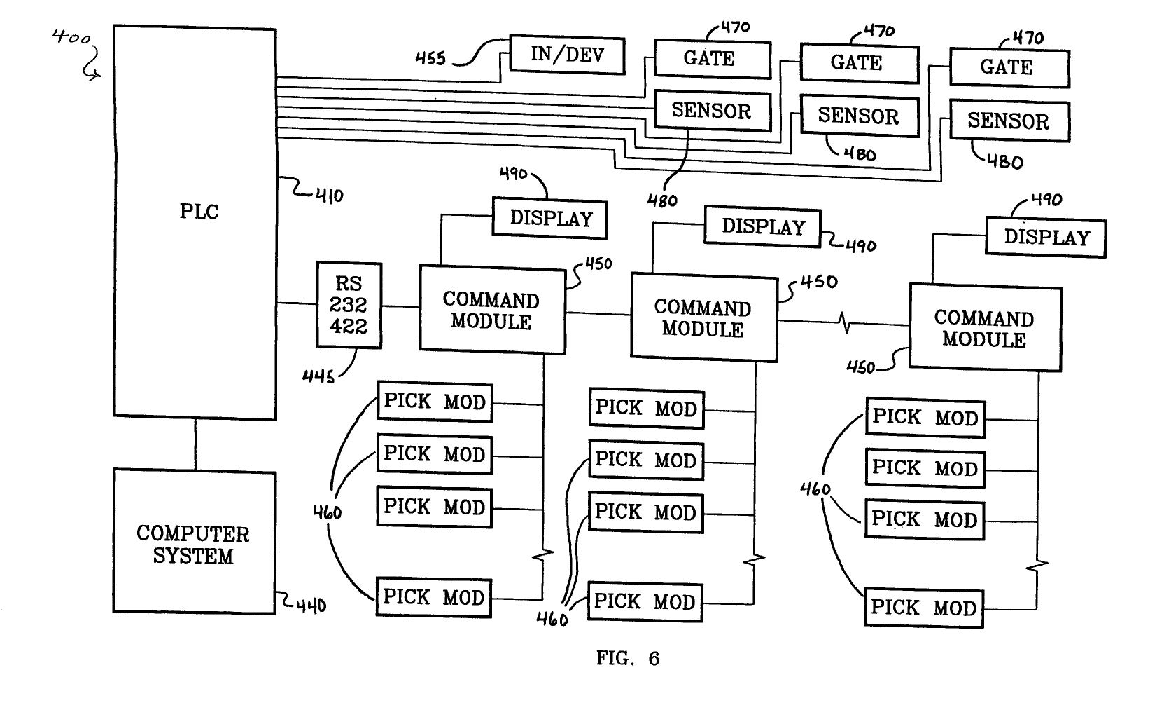

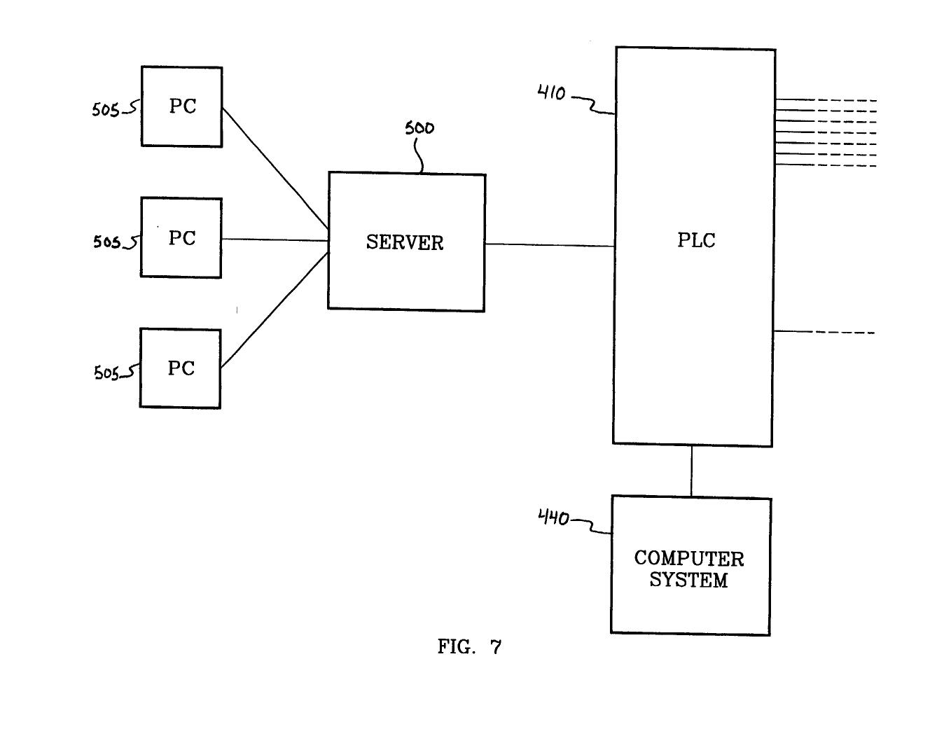

The present invention comprises embodiments of an inventory control system for use with a pick or assembly line. Shown in FIG. 5 is a pick or assembly line 300 according to the present invention and, shown in FIG. 6, is an inventory control system 400 according to the invention for use with the pick line 300 of FIG. 5. The inventory control system 400, as will be described in greater detail below, incorporates a programmable logic controller, or PLC. Such a PLC driven inventory control system 400 will find general applicability in the manufacturing and industrial sector, in warehousing and distribution centers, in large department stores, and in any other setting requiring the control and handling of goods and materials.

Programmable logic controllers are well known in the art. Generally, a PLC is a multipurpose controller exhibiting behavior or set of behaviors that can be modified or programmed as needed. Behaviors that may be programmed include logic, sequencing, timing, counting, and arithmetic. Essentially, a PLC functions by looking at its inputs and, depending upon their state, as well as a program entered into the PLC to produce a desired result, tuning on or off its outputs. Common inputs include motor speed, temperature, pressure, volumetric flow, and other similar input signals as known in the art. Outputs from a PLC may include a signal to speed up or slow down a motor or conveyor, to move or rotate a robotic arm or other mechanical linkage, to open or close a relay, to adjust a pressure, to raise or lower a temperature, as well as many other types of command signals.

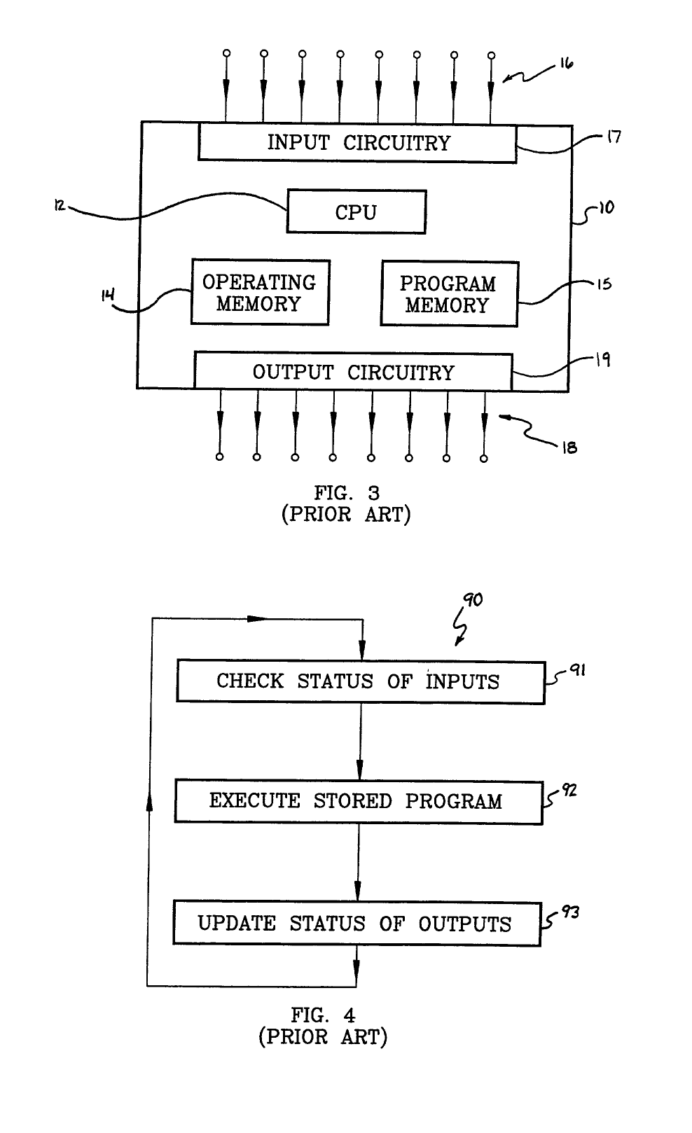

An exemplary embodiment of a conventional PLC 10 is shown in FIG. 3. Such a conventional PLC 10 generally comprises a central processing unit (CPU) 12 and at least two types of memory, operating memory 14 and program memory 15. Program memory 15 generally comprises non-volatile, programmable memory—such as EPROM, EEPROM, FLASH, antifuse, and SRAM memory technologies— used for storing a set of instructions governing the behavior of the PLC 10. The operating memory 14 generally comprises RAM-type memory used by the PLC 10 for program operation and for temporary storage of data during operation. The conventional PLC 10 further comprises a plurality of input terminals 16 and accompanying input circuitry 17 and a plurality of output terminals 18 and accompanying output circuitry 19. Input and output terminals 16, 18 and accompanying circuitry 17, 19 serve as the interface between the PLC 10 and the external processes and/or systems to be monitored or controlled.

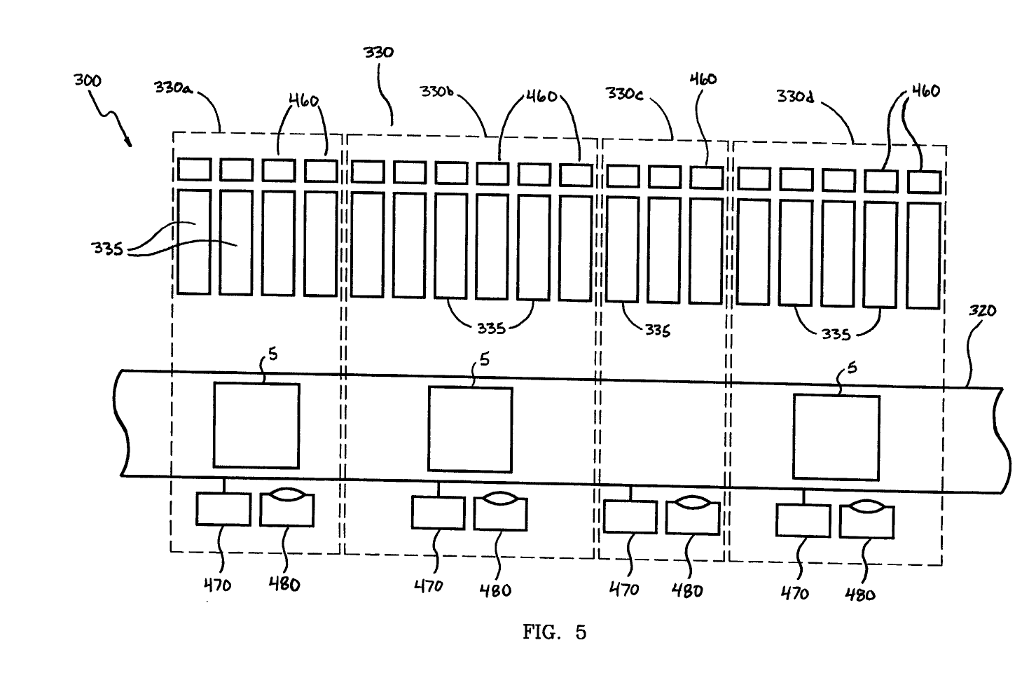

During operation of the PLC 10, the input terminals 16 are continuously monitored and input data is copied into the operating memory 14. The CPU 12 steps through the programmed stored in the program memory 15 and, based upon the program sequence and the state of the inputs at input terminals 16, changes or updates the state of the outputs at output terminals 18. Generally, a PLC 10 works by continually executing or scanning a program, or set of programs, stored in its program memory 15. A typical “scan cycle” is shown in FIG. 4 and is generally denoted as 90. The scan cycle 90 begins with the step 91 of checking the status of a PLC's inputs. For example, an input may be on (i.e., a “1”) or an input may be off (i.e., a “0”). Subsequently, the step 92 of executing a program stored on the PLC is performed one instruction at a time, and the program will produce a set of desired outputs based upon the status of the inputs. Finally, the step 93 of updating the PLC's outputs is performed. Again, the outputs are based upon the set of instructions contained in the executed program and the state of the inputs to the PLC.

After the final step 93 of updating the outputs, the PLC returns to the initial step 91 of checking the inputs and the scan cycle 90 is repeated continuously. In addition, the scan cycle 90 may include steps other than those shown and described with respect to FIG. 4. By way of example, the scan cycle 90 may include a system check, updating internal counters, and updating internal timer values.

Most PLCs can be easily programmed through symbolic logic using a personal computer by maintenance personnel having only minimal programming skills. Symbolic logic-based programming languages include ladder diagrams, function blocks, and sequential function charts. However, most PLCs are adapted to accommodate programming using textual languages, such as C or Pascal, for advanced programmers. Further advantages of PLCs include ruggedness, no moving parts resulting in high reliability and little maintenance, small size, low cost, and electrical noise immunity. Further, PLCs are widely commercially available in a number of common architectures, including Simple Programmable Logic Devices (SPLDs), Complex Programmable Logic Devices (CPLDs), Field Programmable Gate Arrays (FPGAs), and Field Programmable Interconnects (FPICs), although there exist vendor-specific variants within each architecture type.

Conventional PLCs typically employ an RS-232 compatible format for communications—both inputs and outputs— with external devices, such as industrial machine tools, conveyors, and the like. The RS-232, or Recommended Standard number 232, prescribes a device-to-device interface employing serial, binary data interchange that is asynchronous (i.e., no synchronization between devices exchanging data bits). The newer RS-422 standard—which is RS-232 compatible, but is more reliable, exhibits higher speed, and is more immune to the high electrical noise prevalent in a manufacturing environment where high current machinery is in operation— is often employed in the industrial machines and/or process controls with which a PLC must interface. Thus, a PLC having RS-422 compatibility, or a PLC in conjunction with an RS-232/RS-422 converter, must usually be employed in most industrial or manufacturing applications. It should also be noted, as those of ordinary skill in the art will appreciate, that a PLC may be configured for communication with external devices using other data exchange formats, such as parallel data transfer or synchronous data transfer (i.e., devices exchange data bit in synchrony with one another).

Referring again to FIG. 5, the pick line 300 includes a conveyor 320, or other suitable transport device, extending and movable through a plurality of product zones 330, such as, for example, four product zones 330a-d . The conveyer 320 is configured to move one or more pallets or trays 5 sequentially through the product zones 330. Within each of the product zones 330a-d are a plurality of part bins 335, each part bin 335 adapted to store or retain a specific type or classification of part or inventory item, as desired. Generally, all of the part bins 335 within a particular product zone 330 will store parts or inventory items of a particular product group. As a pallet 5 travels through a product zone 330, all or a specified portion of the parts stored within the part bins 335 of that product zone 330 are loaded onto the pallet 5. The various parts collected on a pallet 5 may, for example, be incorporated into a device being assembled on the pallet 5, retained on the pallet 5 for subsequent assembly, or simply collected on the pallet 5 for shipment to a customer.

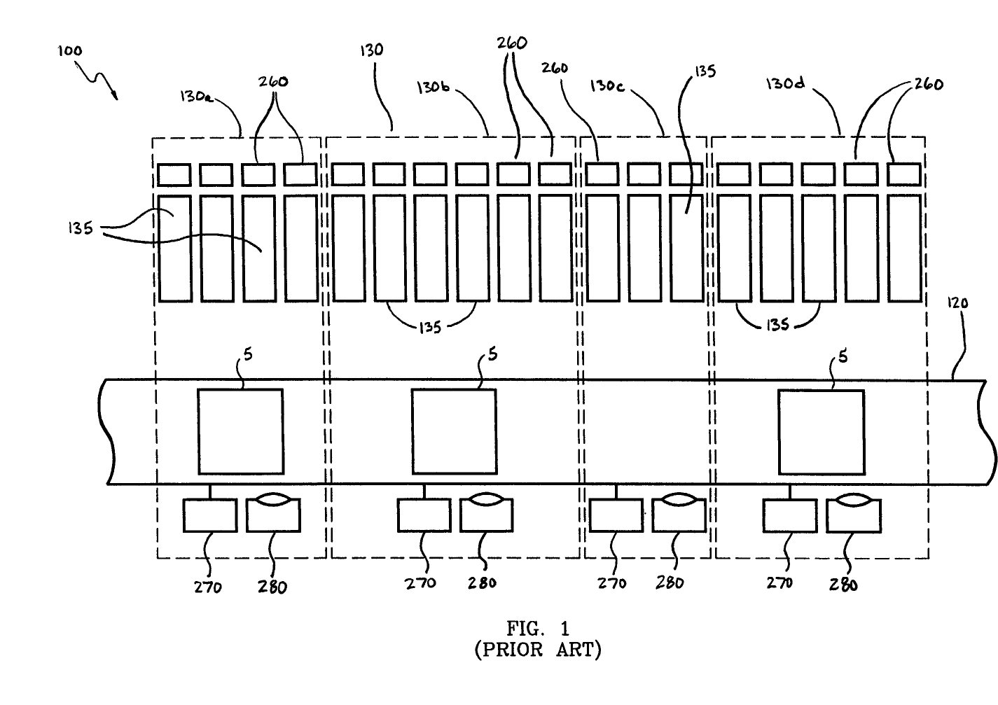

By way of example, as described above for the pick line 100 of FIG. 1, the pick line 300 may comprise a portion of a computer manufacturing facility. Each of the product zones 330a-d includes a plurality of part bins 335, each part bin 335 containing a specific part, wherein all of the part bins 335 of a product zone 330 retain a particular grouping of parts. For example, the first product zone 330a may include a plurality of types of computer housings or chassis, each part bin 335 of that product zone 330a retaining a specific size or configuration of computer chassis. A second product zone 330b may include a plurality of types of motherboards, wherein each part bin 335 within the second product zone 330b retains a specific model or configuration of motherboard. A third product zone 330c may include a plurality of types of memory modules, each part bin 335 of the third product zone 330c storing a particular type or size of memory module. Yet another product zone 330d may include a plurality of types of hard disk drives, a particular model or type of hard disk drive being stored within each of the part bins 335 within that product zone 330d. Other product zones may includes product groupings of video cards, video displays, disk drives, CD-ROM drives, keyboards, sound cards, and the like.

As the various computer parts are transferred from the part bins 335 within a product zone 330 to a pallet 5 present in that product zone 330, those parts may be incorporated into a computer being assembled on the pallet 5. Alternatively, all of the parts transferred from the part bins 335 as the pallet 5 traverses the product zones 330a-d on conveyer 320 may be collected on the pallet 5, and the pallet 5 transferred elsewhere in the manufacturing facility for assembly. As a further alternative, all of the computer parts transferred from the part bins 335 of pick line 300 may simply be collected on the pallet 5 for direct shipment to a customer. Also, although only one pick line 300 is depicted in FIG. 5, those of ordinary skill in the art will understand that a computer manufacturing facility, as well as other types of manufacturing facilities and warehouses, may employ multiple pick or assembly lines 300.

Referring again to FIG. 5, each product zone 330a-d includes a gate 470 linked, either electrically or mechanically, to the conveyer 320 for halting movement thereof when a pallet 5 has entered that product zone 330 to receive an inventory item or items. The gate 470 may comprise a brake or other mechanical linkage configured to physically contact the conveyer 320 and halt movement thereof. Alternatively, the gate 470 may comprise an electrical switch that is electrically coupled to the conveyor's drive motor and configured to cut off power thereto. Each product zone 330a-d also includes at least one sensor 480 for sensing the presence of a pallet 5 in that product zone 330. The sensor 480 may comprise any suitable sensor known in the art, including optical sensors, capacitive sensors, inductive sensors, and contact-type proximity sensors. Further, each part bin 335 of the pick line 300 includes a pick module 460 associated therewith, the operation of the pick modules 460 to be explained in greater detail below.

Referring now to FIG. 6, the inventory control system 600 according to the invention includes a computer system 440 electrically coupled to a PLC 410, which, in turn is electrically coupled to a plurality of command modules 450. The PLC 410 is further coupled to an input device 455, as well as gates 470 and sensors 480. The PLC 410 may comprise any suitable type of PLC known in the art, as noted above. Further, the PLC 410 may be programmed using a personal computer (not shown) through ladder logic or other symbolic programming to perform various functions, as will be explained in greater detail below. It should also be noted that an RS-232/422 adapter 445 may be required to couple the PLC 410 to, for example, the command modules 450. Similarly, an RS-232 compatible communications link (not shown) may be present between the computer system 440 and PLC 410. However, the PLC 410 may alternatively be configured for direct coupling to some components of the pick line 300 and inventory control system 400, such as, by way of example, the input device 455, gates 470, and sensors 480, as is shown in FIG. 6.

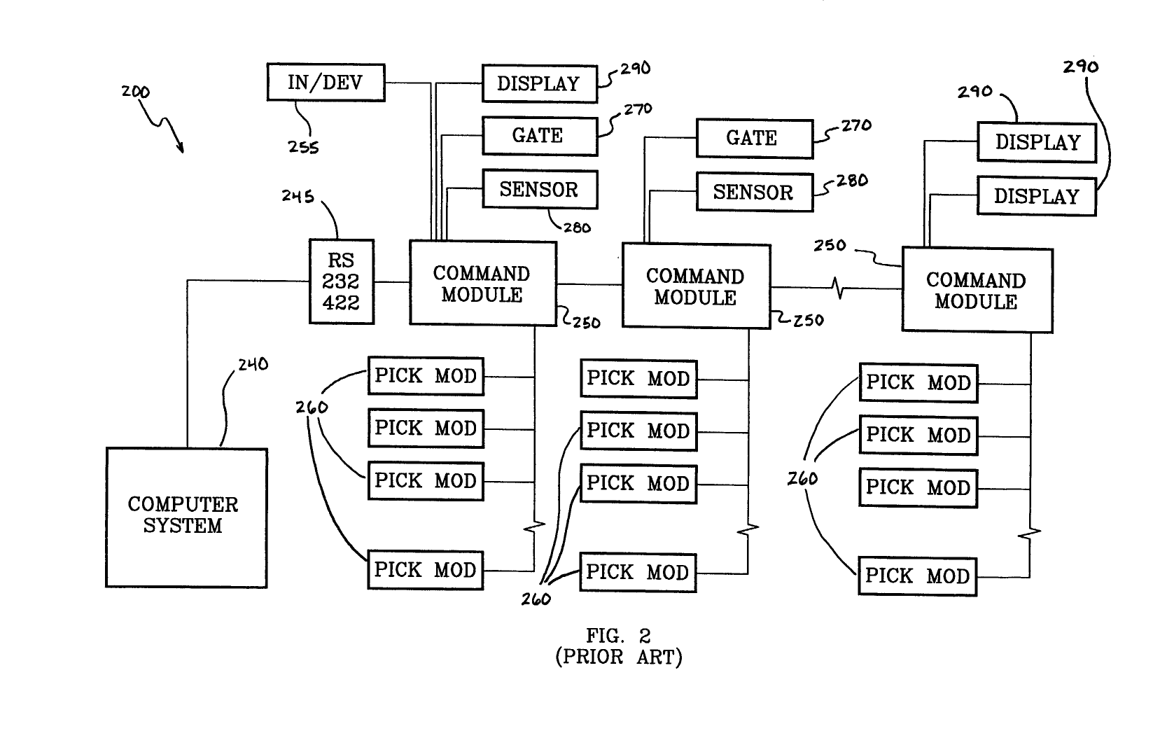

The computer system 440 generally comprises a computer or server configured to store and maintain a database of inventory items to be consumed in the pick or assembly line 300. In addition to maintaining an inventory database, such a computer or server may also maintain a database of outstanding work order or job numbers to be processed. However, unlike the conventional inventory control system 200 shown and described above with respect to FIG. 2, the computer system 440 contains minimal or no programming for control of the inventory control system 400 and pick line 300. Those of ordinary skill in the art will, once again, understand that the computer system 440 may actually comprise separate components. For example, the computer system 440 may comprise a server adapted to store and update a database of inventory items and a separate computer adapted to function as an interface between the server and PLC 410 and to transfer data therebetween.

The command modules 450 are connected in series to the PLC 410 via, if necessary, the RS-232/422 adapter 445. Electrically coupled to each of the command modules 450 are a plurality of the pick modules 460. A command module may be coupled to a portion of the pick modules 460 for a particular product zone 330a-d , all of the pick modules 460 for a particular product zone 330a-d , or the pick modules 460 associated with two or more product zones 330a-d , as is desired. Each command module 450 functions as a data link between the PLC 410 and the pick modules 460. For example, a command module 450 may format data received from the PLC 410 for use by a pick module 460, or a command module 450 may format data received from a pick module 460 for use by the PLC 410. However, as should be realized from the description above, there is not necessarily a correspondence between a command module 450 and one of the product zones 330a-d , because a command module 450 may be electrically coupled to the pick modules 460 of two or more product zones 330a-d.

As noted above, a pick module 460 is associated with one of the part bins 335 of the pick line 300, the pick module 460 being attached to, or in close proximity to, its associated part bin 335. A pick module 460 comprises a user interface including at least a user-readable output, such as a digital display, and a user input, such as a button or a plurality of buttons (i.e., a keypad). The user-readable output may identify—e.g., by simply illuminating a digital display or, alternatively, by illuminating an LED— for an operator which part bin or part bins 335 are to have parts removed therefrom. Further, for a pick module 460 that has been identified (i.e., illuminated), the user-readable output may also provide the operator with the number of parts to be withdrawn from its corresponding part bin 335, as well as a work order or invoice number, a part number, and/or other suitable information as desired. The user input on a pick module 460 enables an operator to inform—by, for example, pressing a button or a series of buttons— the PLC 410 that the specified number of parts from an identified part bin 335 have been transferred to a pallet 5. Alternatively, and particularly suitable to the present invention, the user input of a pick module 460 may comprise a bar code scanner mounted on the associated part bin 335 that scans the bar code number of a part as it is removed from that part bin 335, the bar code number then being relayed back to the PLC 410.

The inventory control system 400 may also include a plurality of video displays 490, at least one video display generally being associated with each of the product zones 330a-d . A video display 490, such as an ASCII display, can be used to provide information to a user, including work order or invoice numbers, part numbers, error messages, and other suitable information, as desired. Each video display 490 is also coupled to the PLC 410 via one of the command modules 450.

The input device 455 coupled to PLC 410 enables an operator to input a command or data into the inventory control system 400 informing the inventory control system 400 that the operator is commencing a job, such as processing a work order. By way of example, the input device 455 may comprise a bar code scanner configured to scan a bar code provided on a hard-copy of a work order or invoice. Upon scanning the bar code and inputting the corresponding work order number, the inventory control system 400 is enabled or turned on and commences operation. Based upon the work order number, the inventory control system 400 knows what data to download or transfer out of the computer system 440 to PLC 410. Alternatively, the inventory control system 400 may be enabled by a command received from the PLC 410 or computer system 440, or simply by the press of a button or switch.

The PLC 410 is programmed to interface with the computer system 440 and with the command modules 450, input device 455, pick modules 460, gates 470, sensors 480, and video displays 490. The PLC 410 essentially replaces the computer system 240 of the conventional inventory control system 200, although a computer system 440 is still necessary to provide a database. It should be noted that, although only one PLC 410 is shown in FIG. 6, an inventory control system according to the invention may include a separate PLC 410 for each of multiple pick lines in a manufacturing facility or, alternatively, only one PLC 410 may be used to control multiple pick lines, as desired. The PLC 410 may be programmed, either prior to operation of the inventory control system 400 or in real time during operation thereof, to perform a number of functions.

For example, the PLC 410 is programmed to receive work order data from the database of computer system 440 and to format that data for use by command modules 450, and, similarly, the PLC 410 is programmed to receive electrical signals from the command modules 450 and to format those signals for use by the computer system 410, such that its inventory and work order databases may be updated. Also, the programming in PLC 410 can be altered to modify the information displayed at pick modules 460, as well as to modify the information provided to an operator at the video displays 490 or to re-display information thereon at the request of an operator.

The PLC 410 is also programmed to control operation of the numerous components comprising the pick line 300 and inventory control system 400. For example, the PLC 410 is programmed to receive an input, such as a scanned work order number, from the input device 455 and to subsequently enable or start up operation of the pick line 300 and inventory control system 400, as noted above. Based on the input from input device 455, the PLC 410 can send a signal to the computer system 440 informing the computer system 440 that the PLC 410 is ready to receive work order data. The PLC 410 is programmed to interface with the gate 470 and sensor 480 within each product zone 330a-d and to direct operation of the conveyer 320 through activation of the gate 470, as well as through direct control of the conveyor's drive motor (e.g., motor speed, on/off, etc.). By controlling operation of the gates 470 and conveyor 320, the PLC 410 is capable of adjusting the travel time of a pallet 5 between product zones 330. The PLC 410 is generally able to control any timing parameter associated with operation of the pick line 300 and inventory control system 400.

The PLC 410 is further programmed to track one or more work orders in progress and to internally keep track of the inventory items being picked from the part bins 335 and added to a work order. This information can then be provided to the computer system 440, such that the computer system can update its databases. Further, the PLC 410 may be programmed to collect data relating to inventory transactions and to perform arithmetic operations on that data to generate statistics regarding operation of the pick line 300. This information can be fed back to an operator (via, for example, display devices 490) in real time. Such data can also be used by operators for subsequent research on system efficiency and operation, as well as troubleshooting.

The pick line 300 and inventory control system 400 incorporating PLC 410 having been described above, operation of the pick line 300 in conjunction with the inventory control system 400 and PLC 410 will now be explained. Operation of the pick line 300 and inventory control system 400 will be explained with reference to the example of a computer manufacturing facility, as set forth above. The process begins with the entry of a work order number or other command at the input device 455. Again, the input device 455 may be a bar code scanner for reading a bar code from the hard-copy of a work order. The input device 455 provides the work order number directly to the PLC 410, which then sends a signal to the computer system 440 informing the same that the PLC 410 is ready to receive data associated with that work order number.

Based upon the current work order number, the computer system 440 returns to the PLC 410 a data set identifying all of the inventory items associated with the work order number. The PLC 410 is programmed with the part bin 335 corresponding to each type of part along the pick line 300. The PLC 410 then sends out to the first-in-line command module 450 again, the command modules 450 being connected in series to the PLC 410—a first data set corresponding to all required parts (e.g., a computer chassis) in the first product zone 330a. The first command module 450 receives the data set from the PLC 410 and, for each pick module 460 coupled to the first command module 450 and associated with a part bin 335 in the first product zone 330a containing an identified part, the first command module 450 relays a signal to each of these pick modules 460. The signal provided to a pick module 460 in the first product zone 330a illuminates a light or digital display on that pick module 460 and also provides an indication of how many inventory items to withdraw from the illuminated part bin 335 for transfer to a pallet 5 resting on the conveyer 320 within the first product zone 330a.

Upon illumination of all pick modules 460 associated with a part bin 335 in the first product zone 330a containing a needed part, the operator picks the part or parts from the identified part bins 335 and places the parts on the pallet 5 in the first product zone 330a, the conveyor 320 holding the pallet 5 within the first product zone 330a through action of the first product zone gate 470. As the operator picks the required number of parts from an identified product bin 335 (as noted on the pick module 460 associated with that part bin 335), the operator presses a button or series of buttons on the associated pick module 460 and the pick module 460 transfers a corresponding signal back to its command module 450, and that command module 450, in turn, provides a signal to the PLC 410 indicating that the specified part or parts (i.e., those in the part bin 335 for which the operator pressed the button) have been added to the work order in progress, and the PLC 410 internally keeps track of which items have been added to that work order (specifically, the PLC 410 would typically decrement an internal register for each item removed from inventory). Activation of the button on a pick module 460 also deilluminates that pick module 460, thereby providing an indication to the operator that all necessary parts have been withdrawn from the part bin 335 associated with that pick module 460. All of the identified part bins 335 in the first product zone 330a are processed in a similar fashion by the operator.

Once all of the identified part bins 335 in the first product zone 330a have been processed and the necessary parts placed on the pallet 5, the PLC 410 sends a command signal to the gate 470 of the first product zone 330a, directing that gate 470 to disengage the conveyer 320, enabling the conveyer 320 to transport the pallet 5 in the first product zone 330a to the next or second product zone 330b. The sensor 480 in the second product zone 330b senses the presence of the pallet 5 in the second product zone 330b and provides a corresponding signal to the PLC 410, and the PLC 410 sends a command signal to the second product zone gate 470 directing that gate 470 to engage and halt the conveyer 320, such that the pallet 5 is now in the second product zone 330b. The PLC 410 then sends a second data set to the corresponding command module 450 that identifies all the required parts—e.g., motherboards— for that work order that are located in the second product zone 330b.

Upon receipt of the data set for the second product zone 330b, the appropriate corresponding command module 450 relays the appropriate signals to illuminate the pick modules 460 associated with each part bin 335 in the second product zone 330b containing an identified part or parts, as noted above. The operator then transfers all of the required parts to the pallet 5 resting on the conveyer 320 in the second product zone 330b and, via an operator input at each pick module 460 (i.e., pressing a button), the pick modules 460 provide signals to their respective command modules 450, which, in turn, transfer the information to the PLC 410 so that the PLC 410 can internally track all items being added to the work order (or, in other words, being subtracted from the work order by decrementing an internal register, as noted above).

The above-described process is then continued for all other product zones 330c, 330d until the entire work order has been processed. The gates 470 in the third and fourth product zones 330c, 330d are used to halt the conveyer therein, respectively, such that the third product zone parts—e.g., memory modules— and the fourth product zone parts—e.g., hard disk drives— may be added to the pallet 5, as necessary. It should be noted that, as the pallet 5 is transferred from the first product zone 330a to the second product zone 330b, another pallet 5 may be moved into the first product zone 330a for simultaneous processing of another, separate work order. Also, the PLC 410 may transfer data—such as an error message stating that a particular inventory item has not be added to a work order, as required— via a command module 450 to a display 490, there typically being a display 490 in each product zone 330a-d . An operator in that product zone 330a-d , or moving with a pallet 5 through all product zones 330a-d , can receive that data and take appropriate corrective action.

When a work order has been completed, the PLC 410 may send a signal to the computer system 440, so that the computer system 440 can update, for example, its database of outstanding work orders or its inventory database. Further, as noted above, the PLC 410 can acquire data relating to the processing of numerous work orders and perform arithmetic operations on that data to generate statistics. For example, the PLC 410 may provide data on the average time a pallet 5 spends in each product zone 330a-d , the average time of travel between adjacent product zones 330, the average number of errors per work order, or the average number of errors per product zone 330, as well as other statistics as desired.

If an error in the system is detected, or if it is desired to change display information or statistics generated by the PLC 410, the PLC 410 may be reprogrammed in real time, if necessary, to implement the necessary modifications. If a new part is introduced into a product zone 330, if a part is assigned a new part number or assigned to a different part bin 335, or if it is desired to simply add new part bins 335 and associated pick modules 460, the PLC 410 may be programmed—again, in real time, if necessary— to add a new part, correct a part number or bin assignment, or to add a new part bin 335 and pick module 460. Also, other hardware, such as I/O devices, switches, lights, scanning devices, and the like, may be added to either of the pick line 300 and inventory control system 400 and the PLC 410 easily programmed to accommodate such new hardware. Other operating parameters, such as gate timing or conveyor speed, may also be reprogrammed as necessary without the need to shut down the pick line 300 or inventory control system 400. Reprogramming may be conducted with a PC using ladder logic or other symbolic language, as noted above. In sum, the operation of the pick line 300 and inventory control system 400 may be easily altered during operation by maintenance personnel having only limited training in PLC programming, and there is no need to shut down a computer system—for example, the computer system 240 of the conventional inventory control system 200— and recompile its code in order to make system modifications.

In another embodiment of the present invention, a single command module replaces the plurality of command modules. Each product zone 330a-d is uniquely identified and recognized by the single command module. The single command module receives commands from the PLC 410 and assigns the commands to the corresponding product zone 330a-d in the same manner as described above. In this fashion, the single command module replaces the plurality of command modules.

In yet another embodiment, the computer system 440 sends to the PLC 410 only the identification of each pick module 460 associated with a part bin 335 storing a needed part. In this embodiment, the PLC 410 is not programmed with the part assignments for each part bin 335; therefore, the computer system 440 must identify the necessary part bins 335. Also, for this embodiment, the PLC 410 may receive from the computer system 440 only the data (i.e., identity of pick modules 460) for one product zone 330 at a time. The above-described approach may have particular utility where it is desirable to conserve memory resources on the PLC 410.

In still another embodiment of the present invention, as shown in FIG. 7, a network of PCs 505 is coupled to the PLC 410 by a server 500. Again, an RS-232 compatible communications link (not shown) may be necessary between the PLC 410 and server 500. An operator may log into the server 500 on one of the PC 505 and access data on the PLC 410. For example, an operator may be able to access statistics generated by the PLC 410 relating to processing of numerous work orders on a pick line 300, thereby enabling the operator to perform research or troubleshoot the pick line 300 and inventory control system 400 and, if necessary, to conduct such work in real time during operation. Also, each of the PCs 505 may be configured for inputting commands or data into the PLC 410. Accordingly, an operator can input a work order number at a PC 505 to commence processing of that work order, rather than providing that information to the PLC 410 through input device 455. Further, the PLC 410 may be adapted for reprogramming by one of the PCs 505 via server 500. It should be noted that, although shown in FIG. 7 as separate components, the computer system 440 and server 500 may actually comprise or form a portion of a single system.

The embodiments of a pick line 300 and inventory control system 400 having been herein described, those of ordinary skill in the art will appreciate the many advantages of the present invention. The operation of inventory control system 400 incorporating PLC 410 may be easily modified in real time by reprogramming the PLC 410. Such reprogramming of the PLC 410 may be accomplished using ladder logic or other symbolic languages by maintenance personnel having only limited training in PLC programming. The ability to make changes while the pick line 300 and inventory control system 400 are operating prevents and minimizes production downtime. In addition, the PLC 410 may be programmed to collect data on inventory transactions and to generate statistics relating to operation of the pick line 300 and inventory control system 400 and, further, to provide such feedback to an operator in real time. Also, PLC technology is proven and reliable, and PLCs are widely commercially available in a number of configurations.

The foregoing detailed description and accompanying drawings are only illustrative and not restrictive. They have been provided primarily for a clear and comprehensive understanding of the present invention and no unnecessary limitations are to be understood therefrom. Numerous additions, deletions, and modifications to the illustrated embodiments, as well as alternative arrangements, may be devised by those skilled in the art without departing from the spirit of the present invention and the scope of the appended claims.

What is claimed is:

1. An inventory system, comprising:
a plurality of product zones, each product zone of said plurality of product zones including at least one part bin for storing a plurality of parts, said at least one part bin having an associated pick module;
a computer system including a database; and
a programmable logic controller coupled to said computer system and to said pick module associated with said at least one part bin in each of said plurality of product zones, said programmable logic controller configured to send a signal to said pick module associated with said at least one part bin of at least one of said plurality of product zones in response to data received from said database identifying said at least one part bin of said at least one product zone.

2. The inventory system of claim 1, wherein said data identifies a part number corresponding to a specified part and said programmable logic controller is configured to identify a matching part bin of said at least one part bin in said at least one product zone having said specified part disposed therein and to send said signal to a pick module associated with said matching part bin.

3. The inventory system of claim 1, further comprising a transport device for carrying pallets along a path extending adjacent to each of said plurality of product zones, said programmable logic controller configured to send said signal to said associated pick module when one of said pallets on said transport device is located in said at least one product zone.

4. The inventory system of claim 3, further comprising:
a gate associated with said each product zone and coupled to said programmable logic controller, said gate configured to halt movement of said transport device; and
a sensor associated with said each product zone and coupled to said programmable logic controller;
wherein said programmable logic controller is configured to receive an electrical signal from said sensor when one of said pallets is located in said each product zone and to send a command signal to said gate in response to said electrical signal directing said gate to stop movement of said transport device.

5. The inventory system of claim 1, wherein said programmable logic controller is configured to send a signal to a user-readable output on said associated pick module in said at least one product zone indicative of a number of parts to remove from said at least one part bin.

6. The inventory system of claim 1, wherein said associated pick module in said at least one product zone is configured to send a verification signal to said programmable logic controller when a specified number of parts have been picked from said at least one part bin in said at least one product zone, said programmable logic controller configured to receive said verification signal.

7. The inventory system of claim 6, said programmable logic controller further configured to track progress of a work order in response to said verification signal.

8. The inventory system of claim 1, further comprising at least one video display device associated with one of said plurality of product zones, said programmable logic controller configured to provide a message to an operator on said at least one video display device.

9. The inventory system of claim 1, further comprising:
a server coupled to said programmable logic controller; and
at least one computer coupled to said server, said at least one computer configured to access data stored in said programmable logic controller.

10. The inventory system of claim 9, wherein said programmable logic controller is configured to receive command signals from said at least one computer.

11. The inventory system of claim 1, further comprising an input device coupled to said programmable logic controller, said programmable logic controller configured to execute at least a portion of a stored program in response to a data stream received from said input device.

12. The inventory system of claim 11, wherein said data stream comprises a work order number.

13. The inventory system of claim 1, further comprising at least one command module coupled between said programmable logic controller and said associated pick module of said at least one part bin in each of said plurality of product zones and configured to relay signals from said programmable logic controller to said associated pick module.

14. A method of managing inventory on a pick line, said pick line comprising a plurality of product zones, each of said plurality of product zones including a plurality of part bins for storing parts, each of said plurality of part bins having an associated pick module, said method comprising:
providing a programmable logic controller;
sending data to said programmable logic controller, at least a portion of said data specifying at least one associated pick module;
formatting said at least a portion of said data with said programmable logic controller to produce a formatted signal;
sending said formatted signal from said programmable logic controller to said at least one associated pick module to illuminate a user-readable output on said at least one associated pick module.

15. The method of claim 14, wherein at least another portion of said data identifies a number of parts to be removed from said part pin of said at least one associated pick module, said method further comprising:
formatting said at least another portion of said data with said programmable logic controller to produce another formatted signal; and
sending said another formatted signal from said programmable logic controller to said at least one associated pick module, said user-readable output indicating said number in response to said another formatted signal.

16. A method of managing inventory on a pick line, said pick line comprising a plurality of product zones, each of said plurality of product zones including a plurality of part bins for storing parts, said method comprising:
providing a programmable logic controller;
sending data to said programmable logic controller, said data including at least one specified part; and
identifying with said programmable logic controller a corresponding product zone of said plurality of product zones in which said at least one specified part is located and identifying a corresponding part bin of said plurality of part bins in said corresponding product zone in which said specified part is stored.

17. The method of claim 16, further comprising sending a signal from said programmable logic controller to a pick module associated with said corresponding part bin in said corresponding product zone, said signal identifying said associated pick module for an operator.

18. The method of claim 17, further comprising sending another signal from said programmable logic controller to a user-readable output on said associated pick module indicative of a number of said at least one specified part.

19. The method of claim 16, further comprising providing information to a video display associated with said corresponding product zone with said programmable logic controller.

20. A method of managing inventory on a pick line, said pick line comprising a first product zone including a first plurality of part bins, each of said first plurality of part bins storing a type of part, and at least a second product zone including a second plurality of part bins, each of said second plurality of part bins storing a type of part, said method comprising:
providing a programmable logic controller coupled to a first plurality of pick modules, each of said first plurality of pick modules associated with one of said first plurality of part bins, and coupled to a second plurality of pick modules, each of said second plurality of pick modules associated with one of said second plurality of part bins;
transporting a pallet into said first product zone;
sending data to said programmable logic controller, said data specifying at least one type of part located in said first product zone and at least one other type of part located in said second product zone;
identifying with said programmable logic controller a first matching part bin of said first plurality of part bins in which said at least one type of part is stored;
sending a first signal with said programmable logic controller to a pick module of said first plurality of pick modules associated with said first matching part bin, said first associated pick module illuminating a user-readable output thereof in response to said first signal; and
providing a verification signal from said first associated pick module to said programmable logic controller, said verification signal indicating said at least one type of part has been picked from said first matching part bin and placed on said pallet in said first product zone.

21. The method of claim 20, further comprising:
transporting said pallet into said second product zone in response to said verification signal being received at said programmable logic controller;
identifying with said programmable logic controller a second matching part bin of said second plurality of part bins in which said at least one other type of part is stored;
sending a second signal with said programmable logic controller to a pick module of said second plurality of pick modules associated with said second matching part bin, said second associated pick module illuminating a user-readable output thereof in response to said second signal; and
providing another verification signal from said second associated pick module to said programmable logic controller, said another verification signal indicating said at least one other type of part has been picked from said second matching part bin and placed on said pallet in said second product zone.

22. The method of claim 21, further comprising tracking progress of a work order with said programmable logic controller based on said verification signal and said another verification signal.

23. The method of claim 21, further comprising obtaining inventory transaction data from said verification signal and said another verification signal with said programmable logic controller and performing at least one arithmetic operation on said inventory transaction data with said programmable logic controller.

24. The method of claim 21, further comprising:
displaying a number of said at least one type of part to pick from said first matching part bin with said user-readable output of said pick module associated with said first matching part bin; and
displaying a number of said at least one other type of part to pick from said second matching part bin with said user-readable output of said pick module associated with said second matching part bin.

25. The method of claim 21, further comprising modifying a program stored in said programmable logic controller to effect a change in at least one of said first signal and said second signal.
